(19) United States
(12) Patent Application Publication
(10) Pub. No.: US 2024/0391811 A1
(43) Pub. Date: Nov. 28, 2024

(54) SYSTEM AND METHOD FOR CONTINUOUS METABOLISM OF CONTAMINANTS OF EMERGING CONCERN

(71) Applicant: The Florida State University Research Foundation, Inc., Tallahassee, FL (US)

(72) Inventor: Youneng Tang, Tallahassee, FL (US)

(21) Appl. No.: 18/671,245

(22) Filed: May 22, 2024

Related U.S. Application Data
(60) Provisional application No. 63/468,110, filed on May 22, 2023.

(51) Int. Cl. C02F 3/10; C02F 3/00; C02F 3/08

(52) U.S. Cl. CPC C02F 3/104; C02F 3/085; C02F 3/106; C02F 2003/003; C02F 2203/006; C02F 2305/06

(57) ABSTRACT

Described herein are systems and methods for continuous metabolism of contaminants of emerging concern. An example bioreactor can include at least one screen positioned downstream in relation to the at least one adsorbent layer, wherein: the bioreactor system is configured to retain within the housing the biofilm that becomes detached from the at least one adsorbent layer, the housing is configured to receive through the inlet a flow of an influent comprising water contaminated with the at least one target contaminant, and the bioreactor system is configured to discharge an effluent from the outlet, which comprises water with a lower concentration of the contaminant compared to the influent.

### CROSS-REFERENCE TO RELATED APPLICATIONS

This application claims priority to and the benefit of U.S. Provisional Application No. 63/468,110, titled “SYSTEM AND METHOD FOR CONTINUOUS METABOLISM OF CONTAMINANTS OF EMERGING CONCERN,” filed on May 22, 2023, the content of which is hereby incorporated by reference herein in its entirety.

### FIELD OF THE DISCLOSURE

This disclosure relates generally to bioreactors and more particularly to bioreactors loaded with microbes for metabolizing contaminants of emerging concern (CECs) and methods of treating contaminated water.

### BACKGROUND

Contaminants of emerging concern (CECs) are chemicals that have been recently “discovered” in environmental samples because of improved analytical chemistry detection levels. These CECs may present a risk to human health and aquatic life, may be candidates for future regulation, and typically are not regulated under current environmental laws. Examples of CECs are pharmaceuticals and personal care products (PPCP), endocrine-disrupting chemicals (EDCs) and hormones, and persistent organic pollutants (POPs) such as per- and polyfluoroalkyl substances (PFAS). The widespread use of these chemicals in various commercial and consumer products leads to widespread water contamination.

Unfortunately, the contaminants of emerging concern usually cannot be removed by traditional water treatment plants. A few technologies are available for their removal from water, but they are very expensive. The prior existing technologies for removing contaminants of emerging concern from water fall into the following categories: (1) advanced oxidation or reduction, which is energy intensive and thereby expensive, (2) adsorption, which is expensive due to the need to further dispose of or treat the adsorbents that contain the contaminants, (3) membrane separation, which is also expensive due to the need to further dispose of or treat the brine, and (4) bioreactors, which require the addition of lots of chemicals to promote the growth of bacteria that can degrade the contaminants, and are thereby expensive. The addition of chemicals in traditional bioreactors are necessary since the concentrations of contaminants of emerging concern are typically very low in the environment. This is detrimental to continuous microbial growth. There is a need for systems and methods for reducing concentrations of contaminants of emerging concern from water sources. The systems and methods disclosed herein address these and other needs.

### BRIEF SUMMARY

In some embodiments, a bioreactor system is disclosed, which includes a housing having an inlet and an outlet; at least one adsorbent layer disposed in the housing comprising a biofilm with microbes capable of metabolizing at least one target contaminant; and at least one screen positioned downstream from the at least one adsorbent layer, wherein: the bioreactor system is configured to retain within the housing the biofilm that becomes detached from the at least one adsorbent layer, the housing is configured to receive through the inlet a flow of an influent comprising water contaminated with the at least one target contaminant, and the bioreactor system is configured to discharge an effluent from the outlet, which comprises water with a lower concentration of the contaminant compared to the influent.

In some implementations, the at least one target contaminant comprises at least one of a pharmaceutical and personal care product (PPCP) (e.g., Triclosan, Ibuprofen), an endocrine-disrupting chemical (EDC) and hormone (e.g., Bisphenol A (BPA), Estrone, Polybrominated diphenyl ethers (PBDEs) such as pentabromodiphenyl ether (PentaBDE)), a persistent organic pollutant (POP), a per- and polyfluoroalkyl substance (PFAS) (e.g., 6:2 fluorotelomer alcohol (6:2 FTOH), Perfluorooctane sulfonic acid (PFOS)), a chlorinated organic compound (e.g., 1,2,3-Trichloropropane (TCP)), an explosive substance (e.g., Trinitrotoluene (TNT)), an industrial by-product (e.g., N-nitroso-dimethylamine (NDMA)), and Metolachlor.

In some implementations, the reactor is operated in the up-flow mode, the detached biofilm is retained in the space between the adsorbent layer, and the at least one screen located downstream in relation to the adsorbent layer.

In some implementations, the reactor is operated in a down-flow mode, up-flow mode, side-flow mode, or moving-bed mode, and an additional screen is placed between the at least one adsorbent layer and the at least one screen positioned downstream from the at least one adsorbent layer to contain the at least one layer of adsorbent; the additional screen has openings that are larger than openings of the at least one screen; the detached biofilm passes through openings of the additional screen and is retained between the additional screen and the at least one screen.

In some implementations, the at least one screen positioned downstream from the at least one adsorbent layer comprises a plurality of apertures that each having an opening size between 40-400 μm.

In some implementations, the bioreactor system is configured to be operated to produce an empty bed contact time from about 3 minutes to about 1440 minutes.

In some implementations, at least one micronutrient is disposed in the housing.

In some implementations, the at least one micronutrient comprises a yeast extract having a concentration between 10-100 μg/L.

In some implementations, the at least one adsorbent layer comprises a bed of adsorbent particles.

In some implementations, the bioreactor system further comprises a pump in fluid communication with the inlet.

In accordance with some embodiments, a method of reducing a concentration of a target contaminant in a water source is provided. The method can comprise flowing water from the water source as an influent into the bioreactor system described above, wherein the influent has a first concentration of the target contaminant; and collecting treated water discharged as an effluent from the bioreactor system, wherein the bioreactor system is operated such that the effluent has a second concentration of the target contaminant that is lower than the first concentration of the target contaminant.

In some implementations, the bed of absorbent particles comprises granular activated carbon.

In some implementations, the bioreactor system is operated at conditions to selectively enrich target contaminant metabolizing microbes that are able to degrade the target contaminant.

In accordance with some embodiments, another method of reducing an amount of a target contaminant content in water is provided. The method can comprise: providing the bioreactor system described above; enriching, via an influent, the biofilm within the bioreactor system, which biofilm comprises target contaminant metabolizing microbes; removing the biofilm from the bioreactor system; and injecting the biofilm into a contaminated site, wherein injecting the biofilm into the contaminated site results in in-situ remediation of the contaminated site through bioaugmentation.

In some implementations, the at least one target contaminant comprises at least one of a pharmaceutical and personal care product (PPCP) (e.g., Triclosan, Ibuprofen), an endocrine-disrupting chemical (EDC) and hormone (e.g., Bisphenol A (BPA), Estrone, Polybrominated diphenyl ethers (PBDEs) such as pentabromodiphenyl ether (PentaBDE)), a persistent organic pollutant (POP), a per- and polyfluoroalkyl substance (PFAS) (e.g., 6:2 fluorotelomer alcohol (6:2 FTOH), Perfluorooctane sulfonic acid (PFOS)), a chlorinated organic compound (e.g., 1,2,3-Trichloropropane (TCP)), an explosive substance (e.g., Trinitrotoluene (TNT)), an industrial by-product (e.g., N-nitroso-dimethylamine (NDMA)), and Metolachlor.

### BRIEF DESCRIPTION OF THE DRAWINGS

The detailed description is set forth with respect to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale.

FIG. 1 depicts a bioreactor system in accordance with one or more embodiments of the present disclosure.

FIG. 2A and FIG. 2B are schematic diagrams showing bioreactors in an “up-flow” mode and “down-flow” mode, respectively, in accordance with certain embodiments described herein.

FIG. 3 is a flowchart of an example method in accordance with certain embodiments described herein.

FIG. 4 shows the experiment setup for a conducted study.

FIG. 5A, FIG. 5B, FIG. 5C, and FIG. 5D show the effects of biomass and yeast extract on the removal of metolachlor, 1,2,3-TCP, 6:2 FTOH, and ibuprofen, respectively.

FIG. 6A, FIG. 6B, and FIG. 6C show the effects of mesh size on the removal of metolachlor, 1,2,3-TCP, and 6:2 FTOH, respectively.

FIG. 7A, FIG. 7B, and FIG. 7C show the effects of EBCT on the removal of metolachlor, 1,2,3-TCP, and 6:2 FTOH, respectively.

### DETAILED DESCRIPTION

Bioreactors for reducing concentrations of target contaminants (e.g., CECs) in a water source are disclosed herein. In particular, the inability for bioreactors to effectively reduce target contaminant content in a water source may be remedied by incorporating a screen for retaining detached biofilm. The detached biofilm can be retained between the screen and the adsorbent layer. By incorporating one or more screens to retain the biofilm that naturally detaches from the adsorbent layer in a bioreactor, concentrations of target contaminants in a given water source may be effectively reduced.

### Definitions

To facilitate the understanding of the disclosure set forth herein, a number of terms are defined below. Unless defined otherwise, all technical and scientific terms used herein generally have the same meaning as commonly understood by one of ordinary skill in the art to which this disclosure belongs. Publications cited herein and the materials for which they are cited are specifically incorporated by reference.

As used herein, the terms “may,” “optionally,” and “may optionally” are used interchangeably and are meant to include cases in which the condition occurs as well as cases in which the condition does not occur. Thus, for example, the statement that a formulation “may include an excipient” is meant to include cases in which the formulation includes an excipient as well as cases in which the formulation does not include an excipient.

As used herein, a “water source” refers to any water source contaminated by target contaminants (e.g., CECs such as PPCPs, per- and polyfluoroalkyl substances (PFAS)), such as groundwater, drinking water, wastewater, landfill leachate, and the like. In some embodiments, these terms are used interchangeably. For example, “groundwater” and “drinking water” may refer to the same source of water. In other words, any source of water that is contaminated by a target contaminant may be treated using the bioreactors and methods disclosed herein.

As used herein, a “biofilm” refers to an agglomeration of microbial colonies adhered to a surface such as an adsorbent.

As used herein, an “adsorbent layer” refers to a layer or surface configured to adsorb the at least one contaminant and permit growth and/or attachment of a biofilm.

### General Definitions

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than where noted, all numbers expressing quantities of ingredients, reaction conditions, geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

As used in this specification and the following claims, the terms “comprise” (as well as forms, derivatives, or variations thereof, such as “comprising” and “comprises”) and “include” (as well as forms, derivatives, or variations thereof, such as “including” and “includes”) are inclusive (i.e., open-ended) and do not exclude additional elements or steps. For example, the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. Accordingly, these terms are intended to not only cover the recited element(s) or step(s) but may also include other elements or steps not expressly recited. Furthermore, as used herein, the use of the terms “a”, “an”, and “the” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent of the given numeric value provided such a deviation does not alter the end function or result of the value. Therefore, a value of about 1% can be construed to be a range from 0.9% to 1.1%. Furthermore, a range may be construed to include the start and the end of the range. For example, a range of 10% to 20% (i.e., range of 10%-20%) can includes 10% and also includes 20%, and includes percentages in between 10% and 20%, unless explicitly stated otherwise herein.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein.

Throughout this disclosure, various aspects may be presented in a range format. It should be understood that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6, etc., as well as individual numbers within that range, for example, 1, 2, 3, 4, 5, and 6. This applies regardless of the breadth of the range.

### Bioreactors for Reducing Concentrations of Target Contaminants in Water

Embodiments of the present disclosure provide a novel bioreactor that can remove certain contaminants of emerging concern without the need for adding chemicals. This reduces the major operating costs compared to the conventional bioreactors. The bioreactor is different from the conventional bioreactor by using at least one inexpensive screen to retain biomass in the new reactor to enhance contaminant biodegradation. In some implementations, the screen is positioned downstream of the reactor water flow so that biomass aggregates (referred to as biofilm) detached from the surface of the adsorbents in the reactor are captured and retained. The detached biofilm is retained between the screen and the adsorbent layer. This increases the biomass concentration in the reactor.

Removal of one contaminant of emerging concern, 1,4-dioxane, to below its health-based reference level in water, via a bioreactor with a screen is demonstrated in U.S. Non-Provisional patent application Ser. No. 18/171,575, filed Feb. 20, 2023, entitled “System and Method for Continuous Metabolism of 1,4-Dioxane,” the content of which is incorporated herein in its entirety.

In some embodiments, the empty bed contact time is between about 3 minutes and about 1440 minutes. As used herein, the “empty bed contact time” (EBCT), also called the “empty bed retention time,” refers to the amount of time the contaminated water is in contact with the adsorbent. The EBCT depends on the concentration of the contaminant to be removed and the specific surface area of the adsorptive medium. Without intending to be bound by any particular theory, it is believed that the EBCT has a linear, positive correlation with the target contaminant concentration, and a linear, negative correlation with the surface area of the adsorptive medium. Thus, a middle-ground EBCT exists for a given adsorptive medium surface area. It is believed that this medium empty bed retention time is desired for maximizing the efficiency of the target contaminant removal using a given bioreactor. EBCT may be calculated according to Formula I:

$$EBCT = \frac{Bed Volume ( {ft}^{3} ) \times 7.48 Gallons / {ft}^{3}}{Flow Rate ( gallons / min )} \\ Empty Bed Contact Time \qquad Formula I$$

### Example System

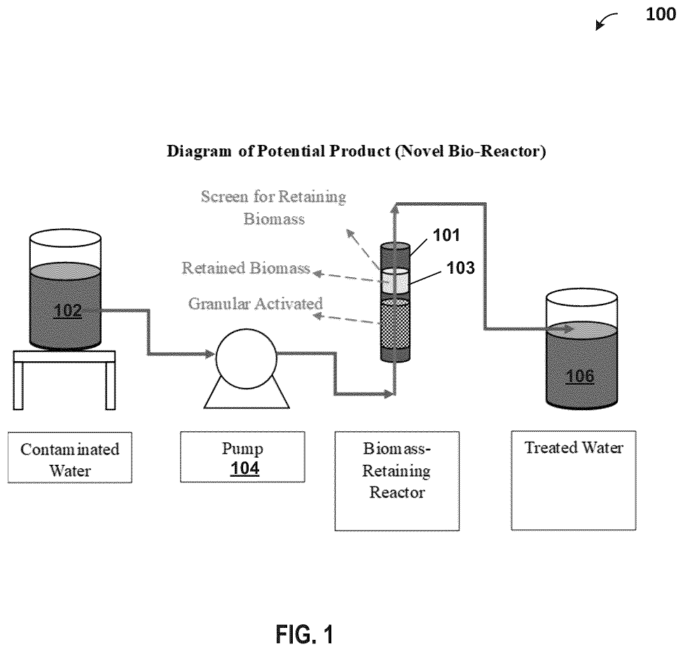

FIG. 1 depicts an exemplary system 100 including a bioreactor 101 in accordance with the present disclosure. The bioreactor 101 comprises a housing and is operatively coupled to a pump 104. The bioreactor 101 is configured to receive an influent 102 (e.g., contaminated water) via one or more apertures on a surface of the bioreactor 101 and/or through a pipe or conduit connected to the bioreactor 101. The bioreactor 101 is configured to process the influent 102 and discharge an effluent 106 (e.g., treated water) via one or more apertures on another surface of the bioreactor 101 and/or through another pipe or conduit connected to the bioreactor 101. As depicted in FIG. 1, the bioreactor 101 includes an adsorbent layer and at least one screen 103 configured to retain at least one target biomass/contaminant. The example screen 103 can comprise a cylindrical or substantially flat substrate positioned within the housing of the bioreactor 101. The screen 103 can comprise metal, a mesh material, or the like, such as, but not limited to, a stainless steel, carbon steel, or aluminum mesh with an aperture size between 40 μm and 200 μm (e.g., 44 μm or 150 μm). In some examples, a diameter of the screen 103 is identical to an internal diameter of the bioreactor 101. In some implementations, the bioreactor 101 is operated to produce an empty bed contact time from about 3 minutes to about 1440 minutes.

In some examples, the target contaminant can include at least one of a pharmaceutical and personal care product (PPCP) (e.g., Triclosan, Ibuprofen), an endocrine-disrupting chemical (EDC) and hormone (e.g., Bisphenol A (BPA), Estrone, Polybrominated diphenyl ethers (PBDEs) such as pentabromodiphenyl ether (PentaBDE)), a persistent organic pollutant (POP), a per- and polyfluoroalkyl substance (PFAS) (e.g., 6:2 fluorotelomer alcohol (6:2 FTOH), Perfluorooctane sulfonic acid (PFOS)), a chlorinated organic compound (e.g., 1,2,3-Trichloropropane (TCP)), an explosive substance (e.g., Trinitrotoluene (TNT)), an industrial by-product (e.g., N-nitroso-dimethylamine (NDMA)), and Metolachlor.

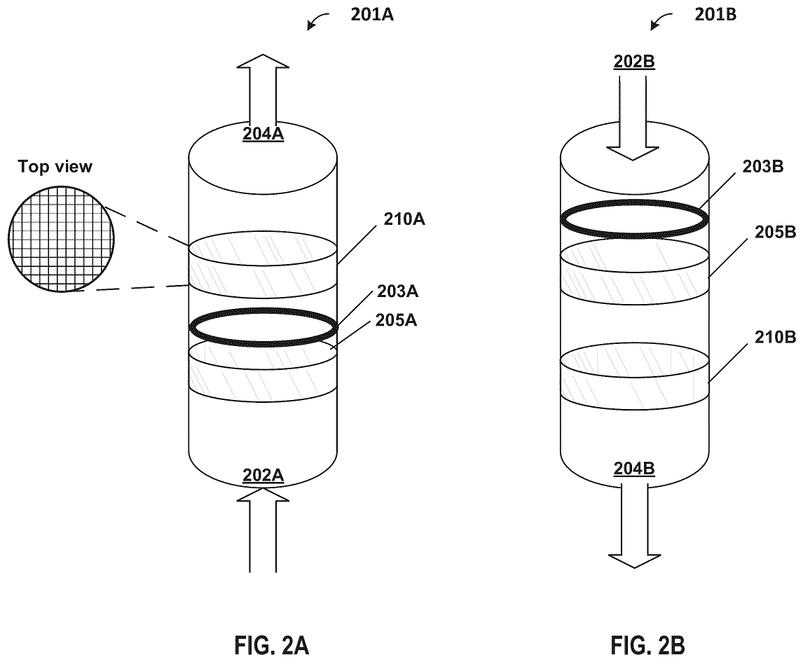

In FIG. 1, the bioreactor 101 (e.g., biomass-retaining reactor) is depicted as accepting an influent 102 at a lower position of the bioreactor 101 and discharging an effluent 106 at an upper position of the bioreactor 101. In this way, the bioreactor 101 is depicted in an “up-flow” mode. In some embodiments, a bioreactor in accordance with the present disclosure can accept an influent at an upper position of the bioreactor and discharge an effluent at a lower position of the bioreactor so that the bioreactor is in a “down-flow” mode as described in connection with FIG. 2B below.

FIG. 2A and FIG. 2B are schematic diagrams showing bioreactors (201A, 201B) in an “up-flow” mode and “down-flow” mode, respectively. In various implementations, a bioreactor in accordance with the present disclosure can be operated in a down-flow mode, side-flow mode, moving-bed mode, or the like.

As shown in FIG. 2A, the example bioreactor 201A comprises a housing having an inlet 202A and an outlet 204A. The bioreactor 201A housing is configured to receive, through the inlet 202A, a flow of an influent comprising water contaminated with the at least one target contaminant. The bioreactor 201A is configured to discharge an effluent from the outlet 204A, which comprises water with a lower concentration of the contaminant compared to the influent. As further depicted, the bioreactor 201A includes at least one adsorbent layer 203A disposed (e.g., positioned) within the housing. The adsorbent layer 203A can comprise a bed of adsorbent particles (e.g., granular activated carbon) and a biofilm with microbes capable of metabolizing at least one target contaminant.

In the example shown in FIG. 2A, The bioreactor 201A includes a first screen 205A positioned upstream from the adsorbent layer 203A and a second screen 210A positioned downstream from the adsorbent layer 203A. A surface of each screen 205A, 210A can comprise a plurality of apertures that each have an opening size between 40-400 μm (in some examples, between 150-400 μm). In some implementations, a detached biofilm is retained in a space between the adsorbent layer 203A and the second screen 210A. In some implementations, an additional screen (i.e., third screen or intermediary screen) is placed between the adsorbent layer 203A and the second screen 210A. The additional screen can have openings that are larger than openings of the second screen 210A such that a detached biofilm passes through openings of the additional screen and is retained between the additional screen and the second screen 210A. In some embodiments, at least one micronutrient is disposed in the bioreactor 201A housing. The at least one micronutrient can comprise a yeast extract having a concentration between 10-100 μg/L.

FIG. 2B shows a bioreactor 201B in a down-flow mode. Similar to the bioreactor 201A described in relation to FIG. 2B, the bioreactor 201B comprises a housing having an inlet 202B and an outlet 204B and is configured to receive through the inlet 202B a flow of an influent comprising water contaminated with the at least one target contaminant. The bioreactor 201B is configured to discharge an effluent from the outlet 204B, which comprises water with a lower concentration of the contaminant compared to the influent. As further depicted, the bioreactor 201B includes at least one adsorbent layer 203B, a first screen 205B, and a second screen 210B positioned downstream from the adsorbent layer 203B.

As illustrated, in a “down-flow mode”, each of the first and second screens 205B, 210B are placed downstream in relation to the adsorbent layer 203. In some implementations, in a “down-flow” mode, the first screen 205B is in contact with an adsorbent, retains the adsorbent, but does not retain the detached biofilm. Additionally, in some embodiments, the first screen 205B is distant from the second screen 210B (i.e., the first screen 205B is at a first distance from the second screen 210B). In some examples, the second screen 210B has smaller openings than the first screen 205B in order to retain the detached biofilm between the first screen 205B and the second screen 210B. The distance between the first and second screens 205B, 210B can provide a space for holding (e.g., keeping, retaining) the detached biofilm. In other embodiments, the bioreactor (e.g., 101, 201A, 201B) can be configured for lateral flow of the influent and/or the effluent, such as to accept an influent at a side position of the bioreactor. Any suitable configuration of bioreactor and influent/effluent streams may be used depending on the needs of the application, and the decision to depict only the “up-flow” and “down-flow” configuration is in the interest of brevity only and is not intended to be limiting.

In various embodiments, the bioreactor includes at least one adsorbent layer (e.g., adsorbent layers 203A, 203B). An exemplary adsorbent layer can include an adsorbent material and a microbial inoculum. Suitable adsorbent materials include those known in the art. In some embodiments, the adsorbent material is granular activated carbon. In some embodiments, the microbial inoculum, also referred to as a biofilm because it is in the form of a microbial “film” on the surface of the adsorbent particles, includes microbes capable of metabolizing various target contaminants. In some embodiments, the bioreactor comprises a column material in the form of a fluidized bed of particles of the adsorbent material. In a fluidized-bed mode, the particles of the adsorbent are retained between two screens: the first screen upstream and the second screen downstream in relation to the adsorbent material. However, the detached biofilm passes through the openings of the second screen and is retained by the third screen that has smaller opening than that in the first and second screens. The detached biofilm is retained between the second and third screens.

The bioreactor can include one or more screens for retaining a biomass. In some implementations, a first screen is positioned upstream from an adsorbent layer. This screen retains the adsorbent. A second screen is positioned downstream from the adsorbent layer. The second screen is configured to ensure the detached biofilms remain within the bioreactor and continue to metabolize the target contaminant. Suitable screens for the second screen are characterized by having a plurality of openings, each opening having a size smaller than at least some of the detached biofilms present within the bioreactor. For example, suitable screens for the second screen may have a plurality of apertures/openings having a size of 40-400 μm. The screen material may be stainless steel.

### Example Method

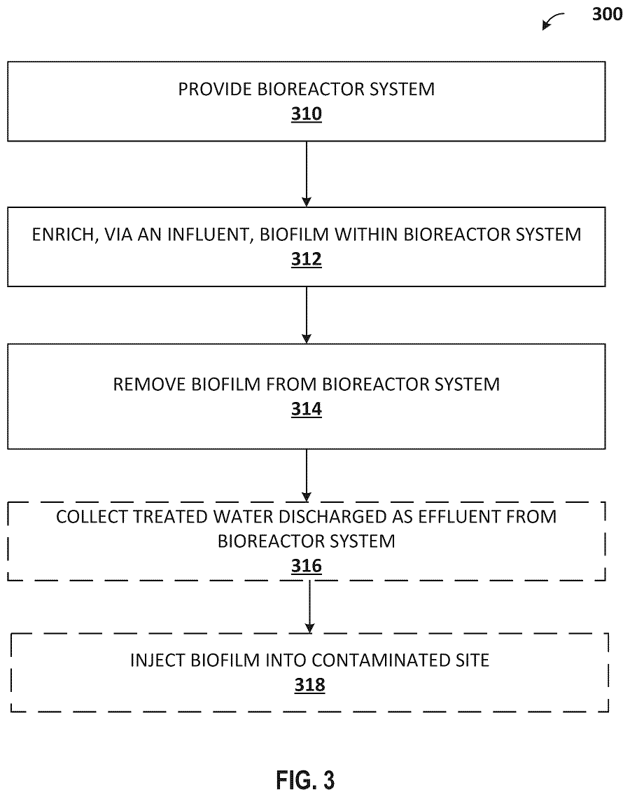

FIG. 3 is a flowchart of an example method 300 for reducing a concentration of at least one target contaminant in a water source in accordance with certain embodiments described herein.

At step 310, the method 300 includes providing a bioreactor system (e.g., the bioreactor system described above in connection with FIG. 1 and/or bioreactors 201A, 201B described in connection with FIG. 2A and FIG. 2B).

At step 312, the method 300 includes enriching, via an influent, biofilm within the bioreactor system. The biofilm can comprise one or more target contaminant metabolizing microbes. Step 312 can comprise flowing water from a water source as an influent into a bioreactor system, where the influent has a particular concentration of at least one target contaminant.

At step 314, the method 300 includes removing the biofilm from the bioreactor system.

Optionally, in some implementations, at step 316, the method 300 includes collecting treated water discharged as an effluent from the bioreactor system.

Optionally, at step 318, the method 300 includes injecting the biofilm into a contaminated site, wherein injecting the biofilm into the contaminated site results in in-situ remediation of the contaminated site through bioaugmentation.

### EXAMPLES

Embodiments of the present disclosure provide systems and methods for removal of contaminants of emerging concern. Various contaminants of emerging concern are summarized in Table 1 below.

TABLE 1
Contaminants of emerging concern

| | Example contaminants | | | | |
|---|---|---|---|---|---|
| Category | Contaminant Name | Uses | Health risks | Regulation | Reference |
| Pharmaceuticals | Triclosan | An | An endocrine | Not regulated | DPH, |
| and Personal | | antibacterial | disruptor | for the time | 2014; Lee |
| Care Products | | agent | | being | et al., |
| (PPCP) | | | | | 2012; |
| | | | | | U.S. EPA, |
| | | | | | 2010b, |
| | Ibuprofen | A painkiller | Under toxicity | Not regulated | Chopra |
| | | | study | for the time | and |
| | | | | being | Kumar, |
| | | | | | 2020; |
| | | | | | Daughton, |
| | | | | | 2010 |
| Endocrine- | Bisphenol A (BPA) | Plastic | cytotoxic and | Predicted no | Klecka et |
| Disrupting | | production | mutagenic, an | effect | al., 2001; |
| Chemicals | | | endocrine | concentrations: | U.S. EPA, |
| (EDCs) and | | | disruptor | 0.18-1.6 μg/L | 2010 |
| Hormones | Estrone | Medication | | Minimum | U.S. EPA, |
| | | | | reporting | 2022 |
| | | | | level: | |
| | | | | 0.002 μg/L | |
| | Polybrominated | Flame | An endocrine | Screening | U.S. EPA, |
| | diphenyl ethers | retardants | disruptor, | level: 40 μg/L | 2017d |
| | (PBDEs): e.g., | | carcinogenic | | |
| | pentabromodiphenyl | | | | |
| | ether (PentaBDE) | | | | |
| Persistent | Per- and | Consumer | a | Not regulated | CEH, |
| Organic | polyfluorinated | products | hormone | for the time | 2018; |
| Pollutants | substances (PFAS): | such as | disrupting | being | Kim et al, |
| (POPs) | e.g., 6:2 | greaseproof | chemical | | 2014 |
| | fluorotelomer | paper | | | |
| | alcohol (6:2 FTOH) | | | | |
| | PFAS: e.g., | Products | adverse | Drinking water | Kwon et |
| | Perfluorooctane | such | reproductive | health | al., 2014; |
| | sulfonic acid | as carpet | and | advisory level: | U.S. EPA, |
| | (PFOS) | and | developmental | 0.07 μg/L | 2017a |
| | | firefighting | effects | | |
| | | foams | | | |
| | Chlorinated organic | An organic | Probable | Maximum | U.S. EPA, |
| | compounds: e.g., | solvent and | carcinogen | contaminant | 2017c |
| | 1,2,3- | a chemical | | level in | |
| | Trichloropropane | intermediate | | Hawaii: | |
| | (TCP) | | | 0.6 μg/L | |
| Other | Explosives: e.g., | Explosive | Possible | lifetime health | Serrano- |
| Contaminants | Trinitrotoluene | | carcinogen | advisory | González |
| | (TNT) | | | guidance level: | et al., |
| | | | | 2 μg/L | 2014; |
| | | | | | U.S. EPA, |
| | | | | | 2014b |
| | Byproducts of | Formed in | Probable | 1 × 10⁻⁶ | Fournier |
| | industrial processes: | the | carcinogen | cancer | et al., |
| | e.g., N-nitroso- | production | | risk level: | 2009; |
| | dimethylamine | of | | 0.7 ng/L | U.S. EPA, |
| | (NDMA) | antioxidants, | | | 2014a |
| | | additives, | | | |
| | | softeners, | | | |
| | | and rocket | | | |
| | | fuel; formed | | | |
| | | in water | | | |
| | | treatment | | | |
| | Metolachlor | A herbicide | Under toxicity | Not regulated | U.S. EPA, |
| | | | study | for the time | 1995 |
| | | | | being | |

Embodiments of the present disclosure evaluate which contaminants can be removed via the novel bioreactor. Additionally, a study was conducted to determine optimal screen opening sizes for retaining biomass aggregates, working ranges of empty bed contact time, and the impact of adding micronutrients (e.g., yeast extract). Embodiments of the present disclosure evaluate the effects of screen opening sizes ranging from 40-400 μm and empty bed contact time ranging from 3 minutes to one day. In some implementations, adding yeast extract at a very low concentration (i.e., 10-100 μg/L) can help to improve contaminant removal. The microbial inoculum for the experiments was a mixed culture that was originally taken from the activated sludge in a wastewater treatment plant and enriched in the lab. This culture already shows the ability to degrade 1,4-dioxane and 6:2 fluorotelomer alcohol (6:2 FTOH, which is a PFAS).

In some embodiments, a bioreactor is provided including at least one adsorbent layer comprising a biofilm (thereon/therein) and a screen positioned downstream or upstream from the at least one adsorbent layer configured to retain detached biofilm ejected from the at least one adsorbent layer. In some embodiments, the biofilm comprises microbes capable of metabolizing various target contaminants, such as, but not limited to, 6:2 FTOH. Without intending to be bound by any particular theory, it is believed that a screen designed to “catch” or retain biofilm that detaches or sloughs off the adsorbent layers increases the lifetime of the biofilm itself and improves removal of target contaminants.

### Experimental Results and Additional Examples

A study was conducted to evaluate the exemplary system and method. It was previously demonstrated that a modified bioreactor can remove one contaminant of emerging concern (CEC) (i.e., 1,4-dioxane). In U.S. Provisional Patent Application No. 63/468,110, it was further described that this reactor can potentially remove more than 10 CECs. The inventor experimentally evaluated the reactor for removal of four CECs—metolachlor, 1,2,3-trichloropropane (TCP), 6:2 Fluorotelomer alcohol (6:2 FTOH), and ibuprofen. Three CECs were effectively removed by this reactor, including metolachlor, 1,2,3-trichloropropane (TCP), and 6:2 Fluorotelomer alcohol (6:2 FTOH). It was found that adding micronutrients (i.e., yeast extract) was not necessary for the biological reactor to work, but yeast extract made the reactor to achieve high removal in a shorter time. It was also found that the mesh size between 44 and 400 μm for the screen successfully captured and retained biomass and increased contaminant removal, but the optimum mesh size was 150 to 440 μm. It was further found that the empty bed contact time (EBCT) of 0.5-12 hour worked for the CECs removal. The optimum EBCT was 8-12 hours for metolachlor and 1,2,3-TCP, and 2-12 hour for 6:2 FTOH. The following species significantly increased in their abundance and seemed to play a significant role in the biodegradation, including Methylotenera mobilis, Desulfosporosinus meridiei, Alicycliphilus denitrificans, Methylotenera versatilis, and Desulfosporosinus lacus.

Contaminants of Emerging Concern (CECs) are chemicals that have been found in waterbodies that may cause ecological or human health impacts and are not currently regulated. One example type of CECs are pharmaceuticals and personal care products (PPCPs). Table 2 summarizes four CECs in the conducted study.

TABLE 2
Contaminants of emerging concern in this study

| | Contaminant | | Health |
|---|---|---|---|
| Category | Name | Uses | risks |
| Pharmaceuticals | Ibuprofen | A painkiller | Under |
| and Personal Care | | | toxicity |
| Products (PPCP) | | | study |
| Persistent Organic | 6:2 Fluorotelomer | In consumer | A hormone |
| Pollutants (POPs) | alcohol | products such as | disrupting |
| | (6:2 FTOH) | greaseproof paper | chemical |
| | 1,2,3- | An organic solvent | Probable |
| | Trichloropropane | and a chemical | carcinogen |
| | (TCP) | intermediate | |
| Pesticides and | Metolachlor | A herbicide | Under |
| herbicides | | | toxicity |
| | | | study |

Many of these CECs come from human waste. Conventional Wastewater Treatment Plants (WWTP) and septic systems were not designed to treat CECs. WWTPs were originally designed to handle easily degradable organic matter like human waste at high concentrations. CECs tend to be large and complex compounds in low concentrations. CECs are usually not removed by conventional WWTP and septic systems.

In this study, four CECs in water were treated with a bioreactor modified from a conventional bioreactor. The modified bioreactor was different from the conventional bioreactor by one inexpensive screen and the space between the screen and the adsorbent to capture and retain biomass in the new reactor to enhance contaminant biodegradation. The screen was positioned downstream of the reactor water flow so that biomass aggregates detached from the surface of the adsorbents in the reactor, usually called biofilm, were captured by the screen and retained in the space between the screen and adsorbent. This increased the biomass in the reactor and therefore the contaminant removal. Due to the increased biomass in the reactor, the need to add primary growth substrates as in conventional biological reactors was eliminated.

It was earlier demonstrated that the modified bioreactor can remove one CEC (i.e., 1,4-dioxane) (See patent application Ser. No. 18/171,575), to below its health-based reference level in water. This study has four objectives. The first objective is to evaluate if this reactor can remove the four CECs summarized in Table 2. The second objective is to evaluate the effects of micronutrients (i.e., yeast extract) on contaminant removal in this reactor. The third objective is to evaluate the effects of the mesh size of the screen for capturing and retaining biomass in this reactor. The fourth objective is to evaluate the effects of the empty bed contact time (EBCT) on contaminant removal in this reactor.

### Methodology

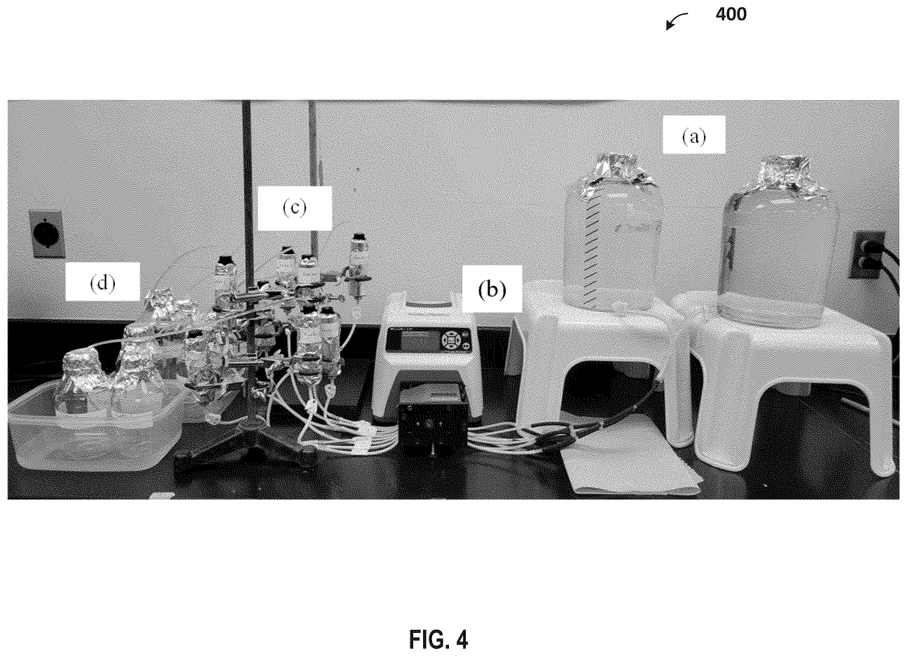

Water Treatment System. Eight reactors that differed in mesh size, EBCT, or micronutrients (i.e., yeast extract) were operated. The difference is summarized in Table 3. FIG. 4 shows the experiment setup 400 for the study. The setup includes: (a) Influent bottles containing contaminated water, (b) Pump, (c) Eight different reactors containing GAC and biomass, and (d) Effluent bottles containing the treated water.

Reactors 1 and 8 were compared to show the effectiveness of the biological reactor for removal of the four CECs. Reactor 8 was an abiotic control, which showed the contaminant removal by GAC adsorption, but not by biodegradation. Reactors 1 and 7 were compared to evaluate the effects of micronutrients. Reactors 1, 2, and 3 were compared to evaluate the effects of mesh size (i.e., 44, 150, & 400 μm). Reactors 1, 4, 5, and 6 were compared to evaluate the effects of EBCT (i.e., 0.5, 2, 8, and 12 hours).

TABLE 3
Operating Conditions of the Reactors

| | Empty Bed | | Presence of | |
|---|---|---|---|---|
| | Contact | | Yeast Extract | |
| Reactor | Time | Presence of | (Concentration | Mesh |
| Name | (EBCT) | Biomass | of 100 μg/L) | Size |
| Reactor 1 | 2 hour | Yes | Yes | 150 μm |
| Reactor 2 | 2 hour | Yes | Yes | 44 μm |
| Reactor 3 | 2 hour | Yes | Yes | 400 μm |
| Reactor 4 | 0.5 hour | Yes | Yes | 150 μm |
| Reactor 5 | 8 hour | Yes | Yes | 150 μm |
| Reactor 6 | 12 hour | Yes | Yes | 150 μm |
| Reactor 7 | 2 hour | Yes | No | 150 μm |
| Reactor 8 | 2 hour | No (Abiotic | Yes | 150 μm |
| | | control) | | |

Each reactor was a plastic column with a volume of 30 mL, was covered with aluminum foil to prevent algae growth, and contained granular activated carbon (GAC) for contaminant adsorption and biomass attachment. The height of GAC was 45 millimeters and the weight was 10.6 grams. In each reactor, there was a bottom screen for holding the GAC. The bottom screen had a mesh size of 150 μm. Approximately three centimeters above the GAC, there was a second screen with mesh size varying between 44 and 400 μm, depending on the reactor (See Table 3 for more information). The space between the GAC top and the second screen was used to retain biofilm that detached from the GAC. Each screen was made of stainless steel. The mesh size referred to the opening size. The seven biological reactors (i.e., Reactors 1-7) were inoculated with biomass that was originated from the bioreactors of a local wastewater treatment plant, and later enriched through contaminant addition of 6:2 FTOH. Before the inoculation, the biomass was confirmed to be able to degrade 6:2 FTOH and then cleaned through the following procedure. First, Biomass was transferred to centrifuge tubes and centrifuged for 10 minutes. After removing the supernatant, nitrate mineral medium was added to wash the pellet. This process was repeated to further wash the biomass. Then the pellet was resuspended in 90 mL of nitrate mineral medium. 12 mL of the mixed liquid was added to each of the seven reactors and then mixed with the GAC in the reactor.

After 24 hours, each reactor was continuously fed with the contaminated water. The contaminated water was a nitrate mineral salts (NMS) media spiked with the four CECs. One liter of NMS contained the following chemicals in deionized water: 1.176 mM NaNO3, 1.28 mM Na2SO4, 0.15 mM MgCl2·6H2O, 0.07 mM CaCl2·2H2O, 0.08 mM FeSO4·7H2O, 3.9 mM KH2PO4, 6.1 mM K2HPO4, 0.002 mM ZnCl2, 0.002 mM MnCl2·4H2O, 0.002 mM H3BO3, 0.004 mM CoCl2.6H2O, 0.004 mM Na2MoO4·2H2O, 0.001 mM CuCl2·2H2O, 0.001 mM NiCl2·6H2O, 0.001 mM Na2WO4·2H2O, 0.001 mM Na2ScO4·5H2O, and 0.001 mM KI. The pH of the media was ˜7. The target contaminant concentrations were 10 μg/L for 1,2,3-trichloropropane (TCP), 100 μg/L for metolachlor and ibuprofen, and 1 μg/L for 6:2 FTOH.

Sampling and Analysis. Samples were taken every one week or so from the influent bottle and the eight effluent bottles. Each sample was filtered with 0.45 μm filter. Ibuprofen was measured using nano liquid chromatography-tandem mass spectrometry (nLC-MS-MS) combined with solid-phase extraction for preconcentration. The other three CECs were measured using gas chromatography-mass spectrometry (GC-MS) combined with solid phase microextraction for preconcentration. Biomass samples were taken from the inoculum at the beginning of the experiments and from the Reactor 1 (See Table 1) after the reactor were operated for approximately four months. DNA was extracted from the biomass samples and sequenced for 16S rDNA to analyze the microbial community.

### Results and Discussion

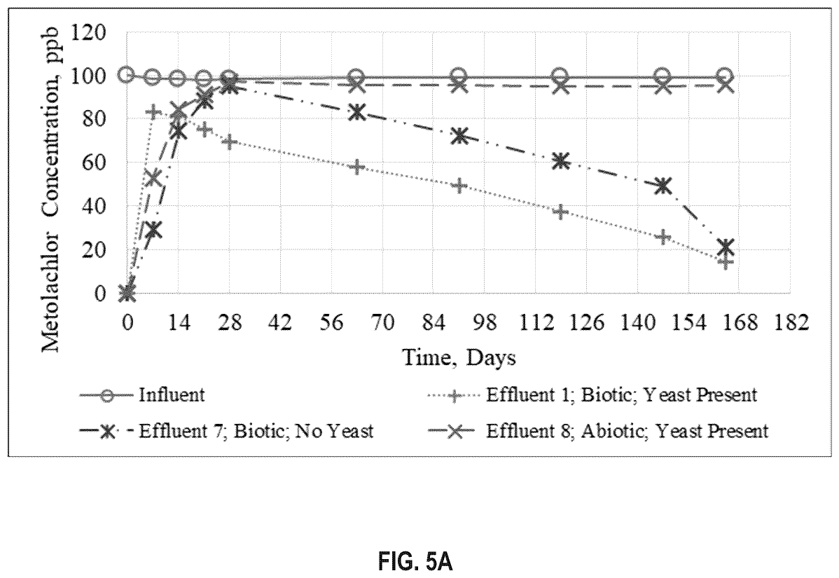

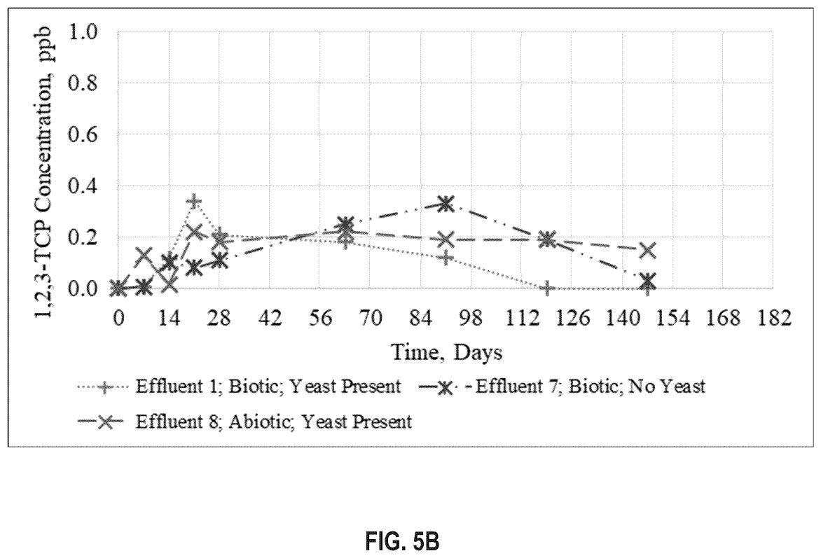

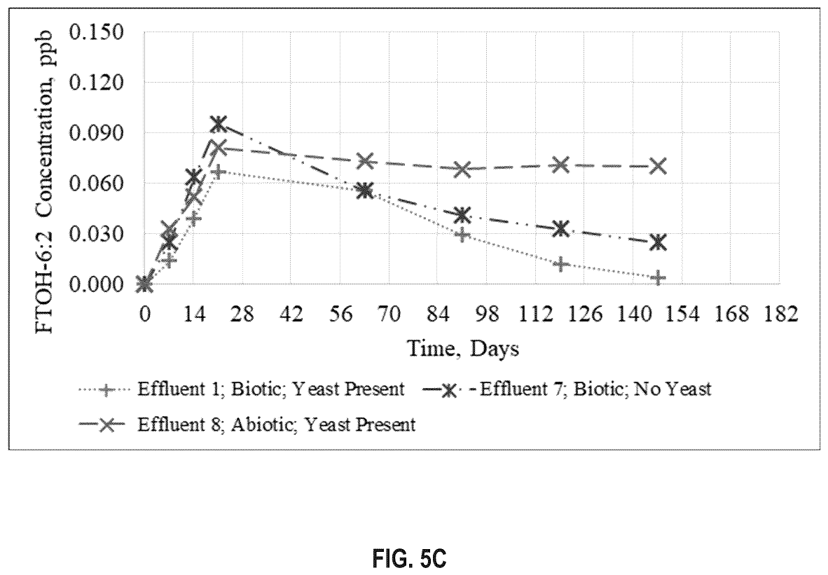

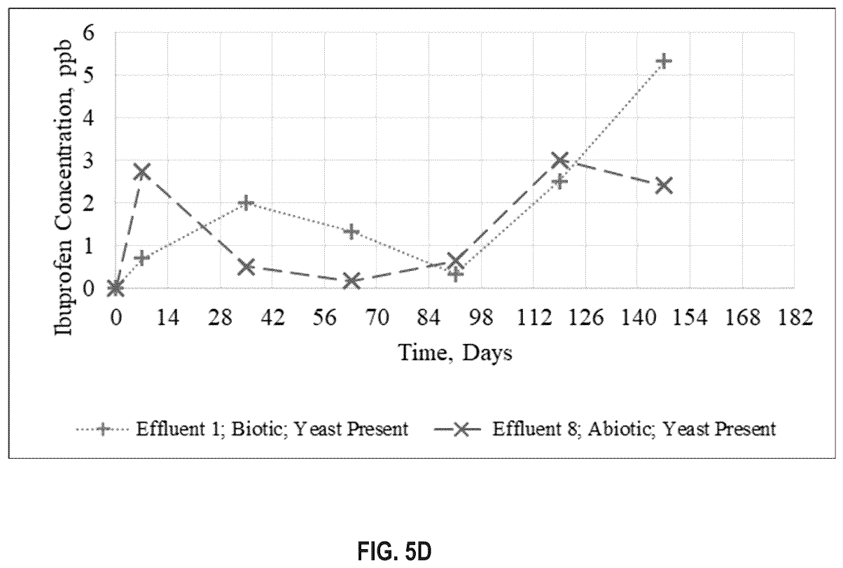

Effects of Biomass and Yeast Extract. FIGS. 5A, 5B, 5C, and 5D show the effects of biomass and yeast extract on the removal of various target contaminants. FIG. 5A show effects of biomass and yeast extract on metolachlor removal, FIG. 5B shows effects of biomass and yeast extract on 1,2,3-TCP removal, and FIG. 5C shows effects of biomass and yeast extract on 6:2 FTOH removal. Note: The influent 1,2,3-TCP concentration was approximately 10 μg/L, which was much higher than the effluent concentrations. Only the effluent concentrations were shown for better comparison. FIG. 5C shows effects of biomass and yeast extract on 6:2 FTOH removal. Note: The influent 6:2 FTOH concentration was approximately 1 μg/L. Only the effluent concentrations were shown for better comparison. FIG. 5D shows effects of biomass and yeast extract on ibuprofen removal. Note: The influent ibuprofen concentration was approximately 100 μg/L. Only the effluent concentrations were shown for better comparison.

Based on the comparison between the abiotic control (i.e., Reactor 8) and the biological reactor with yeast extract present (i.e., Reactor 1), the biological reactor had significantly higher removal for metolachlor, 1,2,3-TCP, and 6:2 FTOH, suggesting biodegradation in addition to adsorption occurring in the biological reactor. For example, the metolachlor removal on the 164th day was 82% in the biological reactor, but only 4% removal in the abiotic control reactor. Based on the trend, the removal for the metolachlor is expected to continuously increase. Regarding 1,2,3-TCP, its removal approached nearly 100% (i.e., being removed to below the detection limit) after the 119th day in the biological reactor, but it was above the detection limit for the abiotic control reactor. The removal of ibuprofen was similar between the biological reactor and the abiotic control, probably due to no ibuprofen-degrading bacteria in the inoculum.

The comparison between the reactors with yeast extract present or absent shows that yeast extract helped the reactor to achieve high contaminant removal at an early stage for all the three biologically removable CECs—metolachlor, 1,2,3-TCP, and 6:2 FTOH. In other words, the biological reactor did not necessarily need yeast extract to work, but adding yeast extract made it work faster. For example, nearly complete removal of 1,2,3-TCP was achieved on the 119th day for the biological reactor with yeast extract present, and on the 147th day for the biological reactor without yeast extract.

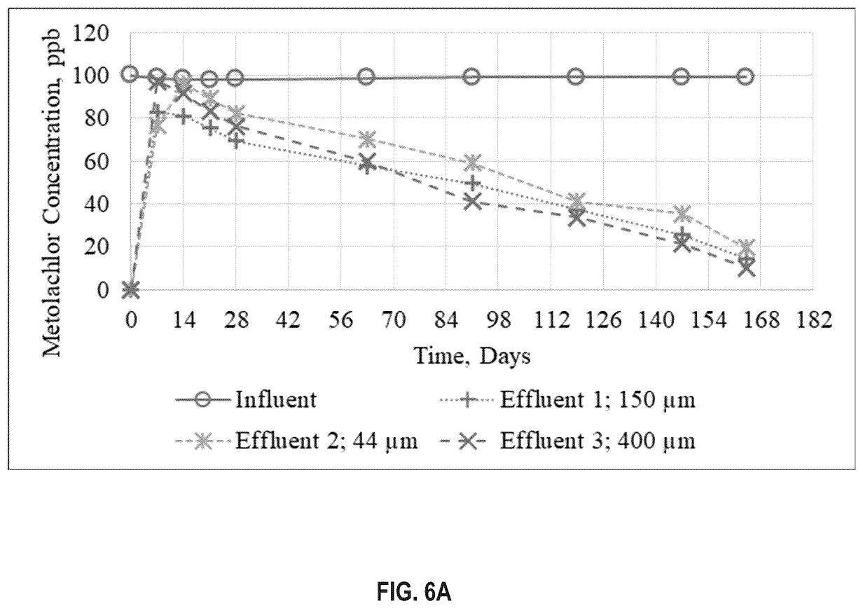

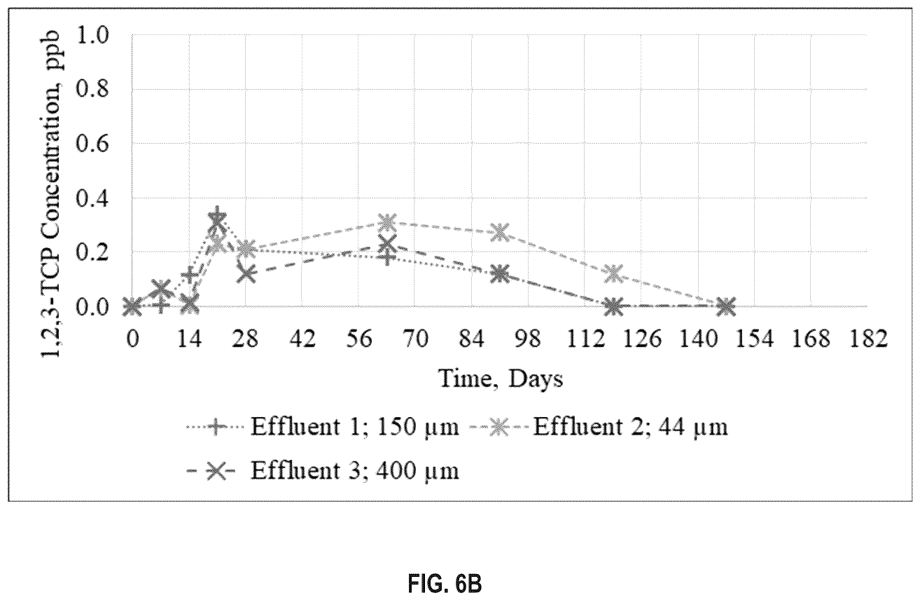

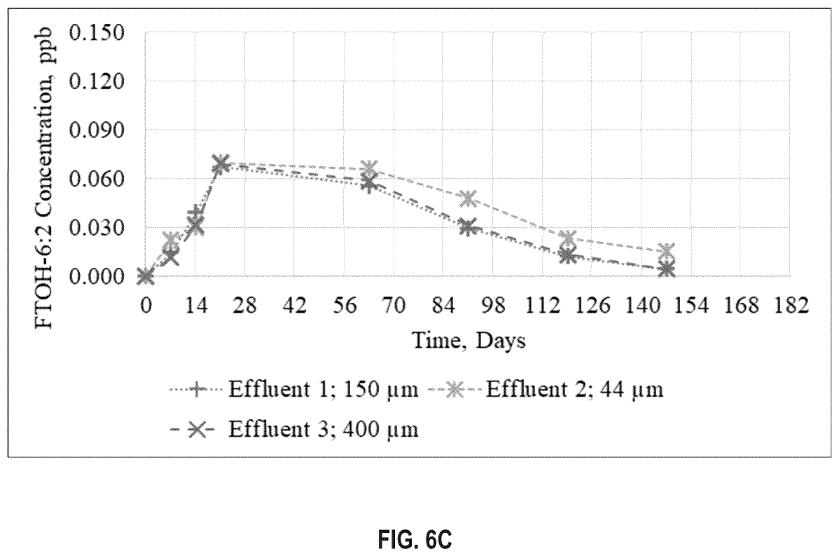

Effect of Mesh Size. FIG. 6A, FIG. 6B, and FIG. 6C show the effects of mesh size on the removal of the three biologically removable CECs—metolachlor, 1,2,3-TCP, and 6:2 FTOH, respectively. The biological reactors with mesh size of 150 (i.e., Reactor 1) and 400 μm (i.e., Reactor 3) had similar contaminant removal efficiency when compared on the same day; and this contaminant removal efficiency was higher than the efficiency for the mesh size of 44 μm. For example, 1,2,3-TCP on the 119th day was removed to below the detection limit for mesh sizes of 150 and 400 μm, but to approximately 0.1 μg/L (=parts per billion=ppb) for mesh size of 44 μm. On the 147th day, 1,2,3-TCP was removed to the detection limit for all the three mesh sizes. Therefore, all the three mesh sizes worked, but the mesh size between 150 and 400 μm was the optimum range since it made the reactor work faster.

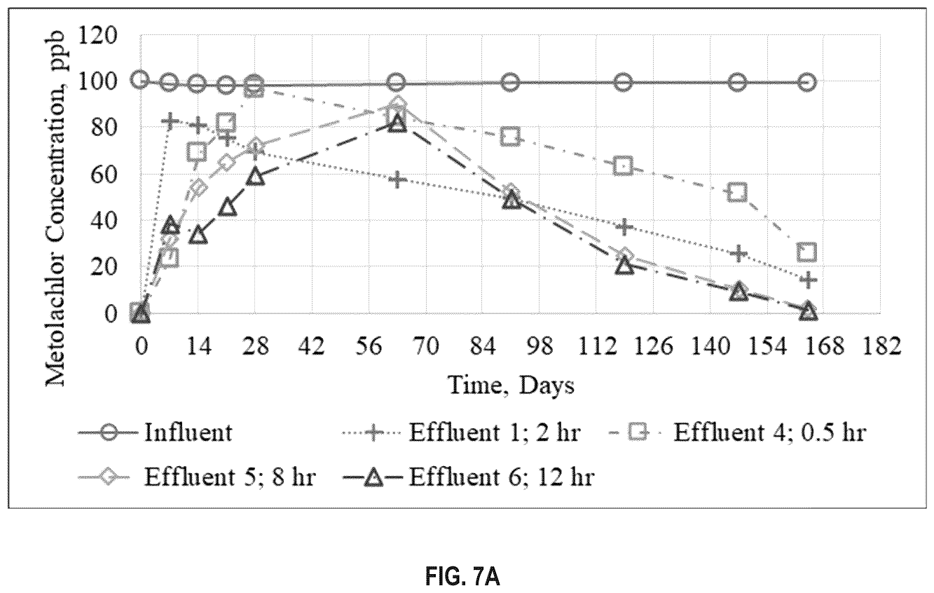

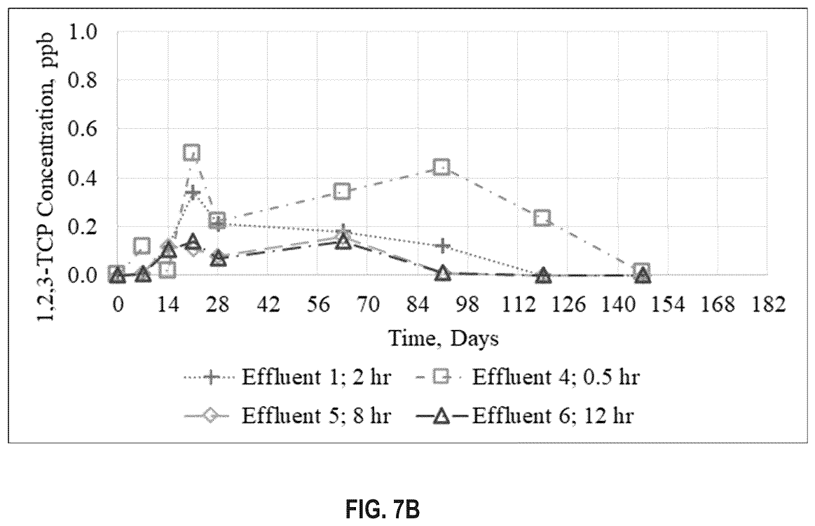

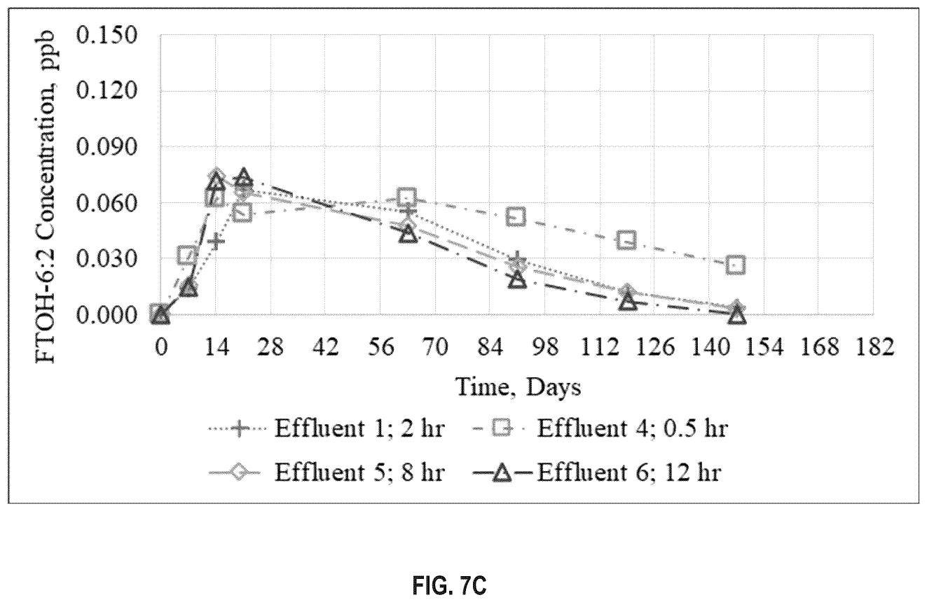

Effects of EBCT. FIG. 7A, FIG. 7B, and FIG. 7C show the effects of EBCT on the removal of the three biologically removable CECs—metolachlor, 1,2,3-TCP, and 6:2 FTOH, respectively. While all the four EBCTs (i.e., 0.5 hour for Reactor 4, 2 hour for Reactor 1, 8 hour for Reactor 5, and 12 hour for Reactor 6) worked, meaning that the reactors had increasing contaminant removal, the optimum EBCT range depended on the contaminant. The optimum EBCT range was 8-12 hours for metolachlor and 1,2,3-TCP, and 2-12 hour for 6:2 FTOH.

Microbial Communities. Table 4 compares the dominant species in the microbial communities of the inoculum and Reactor 1. The following species significantly increased in their abundance and seemed to play a significant role in the biodegradation, including Methylotenera mobilis, Desulfosporosinus meridiei, Alicycliphilus denitrificans, Methylotenera versatilis, and Desulfosporosinus lacus.

TABLE 4
Dominant species in the microbial communities

| Samples | Dominant species in the microbial community | | |
|---|---|---|---|
| | Top Species Classification Results | | |
| | | Number of | % Total |
| | Classification | Reads | Reads |
| Inoculum | Unclassified at Species level | 15,868 | 67.75% |
| | Methyloversatilis universalis | 1,634 | 6.98% |
| | Pedomicrobium australicum | 930 | 3.97% |
| | Thiobacter subterraneus | 918 | 3.92% |
| | Alicycliphilus denitrificans | 620 | 2.65% |
| | Segetibacter aerophilus | 593 | 2.53% |
| | Azoarcus evansii | 330 | 1.41% |
| | Mycoplasma insons | 233 | 0.99% |

Total Species-level Taxonomic Categories Identified: 219. This table
shows the top 8 of 219 classifications.
Note:
The “Other” category in this pie chart is the sum of all classifications
with less than 3.50% abundance.

| | Top Species Classification Results | | |
|---|---|---|---|
| | | Number of | % Total |
| | Classification | Reads | Reads |
| Reactor 1 | Unclassified at Species level | 14,367 | 56.40% |
| sample #1 | Methylotenera mobilis | 4,381 | 17.20% |
| | Desulfosporosinus meridiei | 1,344 | 5.28% |
| | Alicycliphilus denitrificans | 680 | 2.67% |
| | Methylotenera versatilis | 544 | 2.14% |
| | Desulfosporosinus lacus | 398 | 1.56% |
| | Methyloversatilis universalis | 285 | 1.12% |
| | Propionispora hippei | 225 | 0.88% |

Total Species-level Taxonomic Categories Identified: 246. This table
shows the top 8 of 246 classifications.
Note:
The “Other” category in this pie chart is the sum of all classifications
with less than 3.50% abundance.

| | Top Species Classification Results | | |
|---|---|---|---|
| | | Number of | % Total |
| | Classification | Reads | Reads |
| Reactor 1 | Unclassified at Species level | 13,395 | 59.78% |
| sample #2 | Methylotenera mobilis | 3,437 | 15.34% |
| (duplicate of | Desulfosporosinus meridiei | 1,034 | 4.61% |
| Reactor 1 | Alicycliphilus denitrificans | 473 | 2.11% |
| sample #1) | Methylotenera versatilis | 372 | 1.66% |
| | Desulfosporosinus lacus | 278 | 1.24% |
| | Niabella soli | 230 | 1.03% |
| | Pseudoxanthomonas mexicana | 216 | 0.96% |

Total Species-level Taxonomic Categories Identified: 205. This table
shows the top 8 of 205 classifications.
Note:
The “Other” category in this pie chart is the sum of all classifications
with less than 3.50% abundance.

The study demonstrates that embodiments of the present disclosure are suitable and effective for removing the above-identified target contaminants.

While the disclosure has been described with reference to a number of embodiments, it will be understood by those skilled in the art that the disclosure is not limited to such embodiments. Rather, the disclosure can be modified to incorporate any number of variations, alterations, substitutions, or equivalent arrangements not described herein, but which are commensurate with the spirt and scope of the disclosure. Conditional language used herein, such as “can,” “could,” “might,” or “may,” unless specifically stated otherwise, or otherwise understood within the context as used, generally is intended to convey that certain embodiments include, while other embodiments do not include, certain features, elements or functional capabilities. Additionally, while various embodiments of the disclosure have been described, it is to be understood that aspects of the disclosure may include only some of the described embodiments. Accordingly, the disclosure it not to be seen as limited by the foregoing described but is only limited by the scope of the appended claims.

The following patents, applications and publications as listed below and throughout this document are hereby incorporated by reference in their entirety herein.
[1] Adamson D T, Piña E A, Cartwright A E, Rauch S R, Hunter Anderson R, Mohr T, Connor J A. 1,4-Dioxane drinking water occurrence data from the third unregulated contaminant monitoring rule. Sci Total Environ, 2017, 596-597:236-245.
[2] CEH (Center for Environmental Health). Factsheet Fluorinated Additives, 2018, https://ceh.org/wp-content/uploads/2019/07/Fact-Sheet-Fluorinated-Additives-final-1.pdf
[3] Chopra S, Kumar D. Ibuprofen as an emerging organic contaminant in environment, distribution and remediation, Heliyon, 2020, 6 (6): e04087
[4] Daughton C. G. Pharmaceutical Ingredients in Drinking Water: Overview of Occurrence and Significance of Human Exposure, 2010, https://cfpub.epa.gov/si/si_public_file_download.cfm?p_download_id=494550
[5] DPH (Connecticut Department of Public Health). Triclosan Technical Fact Sheet, 2014, https://portal.ct.gov/-/media/Departments-and-gencies/DPH/dph/environmental_health/eoha/pdf/TriclosantechFSpdf.pdf
[6] Fournier D, Hawari J, Halasz A, Streger S H, McClay K R, Masuda H, Hatzinger P B. Aerobic biodegradation of N-nitrosodimethylamine by the propanotroph Rhodococcus ruber ENV425. Appl Environ Microbiol, 2009, 75 (15): 5088-93.
[7] Kim M H, Wang N, Chu K H. 6:2 Fluorotelomer alcohol (6:2 FTOH) biodegradation by multiple microbial species under different physiological conditions. Appl Microbiol Biotechnol, 2014, 98 (4): 1831-40.
[8] Klecka G M, Gonsior S J, West R J, Goodwin P A, Markham D A. Biodegradation of bisphenol A in aquatic environments: river die-away. Environ Toxicol Chem, 2001, 20 (12): 2725-35.
[9] Kwon B G, Lim H J, Na S H, Choi B I, Shin D S, Chung S Y. Biodegradation of perfluorooctanesulfonate (PFOS) as an emerging contaminant. Chemosphere, 2014, 109:221-5.
[10] Lee D G, Zhao F, Rezenom Y H, Russell D H, Chu K H. Biodegradation of triclosan by a wastewater microorganism. Water Res, 2012, 46 (13): 4226-34.
[11] Serrano-González M Y, Chandra R, Castillo-Zacarias C, Robledo-Padilla F, Rostro-Alanis MJ, Parra-Saldivar R. Biotransformation and degradation of 2,4,6-trinitrotoluene by microbial metabolism and their interaction. Defence Technology, 2018, 14 (2): 151-164.
[12] Tang Y. A Review of Challenges and Opportunities for Microbially Removing 1,4-Dioxane to Meet Drinking-Water and Groundwater Guidelines. Curr Opin Environ Sci Health, 2023, 31:100419.
[13] The White House. FACT SHEET: Biden-Harris Administration Launches Plan to Combat PFAS Pollution, 2021, https://www.whitehouse.gov/briefing-room/statements-releases/2021/10/18/fact-sheet-biden-harris-administration-launches-plan-to-combat-pfas-pollution/
[14] U.S. EPA (U.S. Environmental Protection Agency). Pesticides—Fact Sheet for Metolachlor, 1995, https://www3.epa.gov/pesticides/chem_search/reg_actions/reregistration/fs_PC-108801_1-Apr-95.pdf
[15] U.S. EPA (U.S. Environmental Protection Agency). Bisphenol A Action Plan (CASRN 80-05-7) [CA Index Name: Phenol, 4,4′-(1-methylethylidene)bis-], 2010a, https://www.epa.gov/sites/default/files/2015-09/documents/bpa_action_plan.pdf
[16] U.S. EPA (U.S. Environmental Protection Agency). Triclosan Facts, 2010b, https://www3.epa.gov/pesticides/chem_search/reg_actions/reregistration/fs_PC-054901_1-Mar-10.pdf
[17] U.S. EPA (U.S. Environmental Protection Agency). Technical Fact Sheet-N-Nitroso-dimethylamine (NDMA), 2014a, https://www.epa.gov/sites/default/files/2014-03/documents/ffrrofactsheet_contaminant_ndma_january2014_final.pdf.
[18] U.S. EPA (U.S. Environmental Protection Agency). Technical Fact Sheet-2,4,6-Trinitrotoluene (TNT), 2014b, https://www.epa.gov/sites/default/files/2014-03/documents/ffrrofactsheet_contaminant_tnt_january2014_final.pdf
[19] U.S. EPA (U.S. Environmental Protection Agency). Technical Fact Sheet-Perfluorooctane Sulfonate (PFOS) and Perfluorooctanoic Acid (PFOA), 2017a, https://19january2021snapshot.epa.gov/sites/static/files/2017-12/documents/ffrrofactsheet_contaminants_pfos_pfoa_11-20-17_508_0.pdf
[20] U.S. EPA (U.S. Environmental Protection Agency). Technical Fact Sheet-1,4-Dioxane, 2017b, https://www.epa.gov/sites/default/files/2014-03/documents/ffrro_factsheet_contaminant_14-dioxane_january2014_final.pdf
[21] U.S. EPA (U.S. Environmental Protection Agency). Technical Fact Sheet-1,2,3-Trichloropropane (TCP), 2017c, https://www.epa.gov/sites/default/files/2017-10/documents/ffrrofactsheet_contaminants_tcp_9-15-17_508.pdf
[22] U.S. EPA (U.S. Environmental Protection Agency). Technical Fact Sheet-Polybrominated Diphenyl Ethers (PBDEs), 2017d, https://www.epa.gov/sites/default/files/2014-03/documents/ffrrofactsheet_contaminant_perchlorate_january2014_final_0.pdf
[23] U.S. EPA (U.S. Environmental Protection Agency). Third Unregulated Contaminant Monitoring Rule, 2022, https://www.epa.gov/dwucmr/third-unregulated-contaminant-monitoring-rule
[24] U.S. EPA (U.S. Environmental Protection Agency). National Primary Drinking Water Regulations, 2023, https://www.epa.gov/ground-water-and-drinking-water/national-primary-drinking-water-regulations #Organic
[25] Eeso, K.; Gallan, R.; Goukeh, M. N.; Tate, K.; Raja, R. K. B.; Popovic, Z.; Abichou, T., Chen, H.; Locke, B. R.; Tang, Y. Degradation of per- and polyfluoroalkyl substances in landfill leachate by a thin-water-film nonthermal plasma reactor. Waste Management, 2023, 161, 104-115.
[26] Tang, Y. A review of challenges and opportunities for microbially removing 1,4-dioxane to meet drinking-water and groundwater guidelines. Current Opinion in Environmental Science & Health, 2023, 31, 100419
[27] Zhang, Z.; Asefaw, B. K.; Xiong, Y.; Chen, H.; Tang Y. Evidence and mechanisms of selenate reduction to extracellular elemental selenium nanoparticles on the biocathode. Environmental Science & Technology, 2022, 56 (22), 16259-16270
[28] Luo, Y.; Long, X.; Wang, B.; Zhou, C.; Tang, Y.; Krajmalnik-Brown, R.; Rittmann, B. E. A synergistic platform for continuous co-removal of 1,1,1-trichloroethane, trichloroethene, and 1,4-dioxane via catalytic dechlorination followed by biodegradation. Environmental Science & Technology, 2021, 55 (9), 6363-6372.
[29] Rodriguez, C.; Wandell, R. J.; Zhang, Z.; Neurohr, J. M.; Tang, Y.; Rhodes, R.; Kinsey, S. T.; Locke, B. R. Escherichia coli survival in plasma-treated water and in a gas-liquid plasma reactor. Plasma Processes and Polymers, 2020, 17 (12), 2000099.
[30] Bulusu, R. K. M.; Wandell, R. J.; Zhang, Z.; Farahani, M.; Tang, Y.; Locke, B. R. Degradation of PFOA with a nanosecond-pulsed plasma gas-liquid flowing film reactor. Plasma Processes and Polymers, 2020, 17 (8), 2000074.

What is claimed is:

1. A bioreactor system comprising:
a housing having an inlet and an outlet;
at least one adsorbent layer disposed in the housing comprising a biofilm comprising microbes for metabolizing at least one target contaminant; and
at least one screen positioned downstream in relation to the at least one adsorbent layer, wherein:
the bioreactor system is configured to retain within the housing the biofilm that becomes detached from the at least one adsorbent layer,
the housing is configured to receive through the inlet a flow of an influent comprising water contaminated with the at least one target contaminant, and
the bioreactor system is configured to discharge an effluent from the outlet, which comprises water with a lower concentration of the contaminant compared to the influent.

2. The bioreactor system of claim 1, wherein the detached biofilm is retained in the space between the adsorbent layer and the at least one screen located downstream in relation to the adsorbent layer.

3. The bioreactor system of claim 1, wherein the at least one target contaminant comprises at least one of a pharmaceutical and personal care product (PPCP) (e.g., Triclosan, Ibuprofen), an endocrine-disrupting chemical (EDC) and hormone (e.g., Bisphenol A (BPA), Estrone, Polybrominated diphenyl ethers (PBDEs) such as pentabromodiphenyl ether (PentaBDE)), a persistent organic pollutant (POP), a per- and polyfluoroalkyl substance (PFAS) (e.g., 6:2 fluorotelomer alcohol (6:2 FTOH), Perfluorooctane sulfonic acid (PFOS)), a chlorinated organic compound (e.g., 1,2,3-Trichloropropane (TCP)), an explosive substance (e.g., Trinitrotoluene (TNT)), an industrial by-product (e.g., N-nitroso-dimethylamine (NDMA)), and Metolachlor.

4. The bioreactor system of claim 1, operated in a down-flow mode, up-flow mode, side-flow mode, or moving-bed mode, wherein:
an additional screen is placed between the at least one adsorbent layer and the at least one screen to contain the at least one layer of adsorbent,
the additional screen has openings that are larger than openings of the at least one screen,
the detached biofilm passes through openings of the additional screen and is retained between the additional screen and the at least one screen.

5. The bioreactor system of claim 1, wherein:
the at least one screen comprises a plurality of apertures that each having an opening size between 40-400 μm.

6. The bioreactor system of claim 1, which is configured to be operated to produce an empty bed contact time from about 3 minutes to about 1440 minutes.

7. The bioreactor system of claim 1, wherein at least one micronutrient is disposed in the housing.

8. The bioreactor system of claim 7, wherein the at least one micronutrient comprises a yeast extract having a concentration between 10-100 μg/L.

9. The bioreactor system of claim 1, wherein the at least one adsorbent layer comprises a bed of adsorbent particles.

10. The bioreactor system of claim 1, further comprising a pump in fluid communication with the inlet.

11. A method of reducing a concentration of a target contaminant in a water source, the method comprising:
flowing water from the water source as an influent into the bioreactor system of claim 1, wherein the influent has a first concentration of the target contaminant; and
collecting treated water discharged as an effluent from the bioreactor system,
wherein the bioreactor system is operated such that the effluent has a second concentration of the target contaminant that is lower than the first concentration of the target contaminant.

12. The method of claim 11, wherein the at least one adsorbent layer of the bioreactor system comprises a bed of adsorbent particles.

13. The method of claim 12, wherein the bed of absorbent particles comprises granular activated carbon.

14. The method of claim 11, wherein the bioreactor system is operated at conditions to selectively enrich target contaminant metabolizing microbes that are able to degrade the target contaminant.

15. A method of reducing an amount of a target contaminant content in water, the method comprising:
providing the bioreactor system of claim 1;
enriching, via an influent, the biofilm within the bioreactor system, which biofilm comprises target contaminant metabolizing microbes;
removing the biofilm from the bioreactor system; and
injecting the biofilm into a contaminated site, wherein injecting the biofilm into the contaminated site results in in-situ remediation of the contaminated site through bioaugmentation.

16. The method of claim 11 or 15, wherein the at least one target contaminant comprises at least one of a pharmaceutical and personal care product (PPCP) (e.g., Triclosan, Ibuprofen), an endocrine-disrupting chemical (EDC) and hormone (e.g., Bisphenol A (BPA), Estrone, Polybrominated diphenyl ethers (PBDEs) such as pentabromodiphenyl ether (PentaBDE)), a persistent organic pollutant (POP), a per- and polyfluoroalkyl substance (PFAS) (e.g., 6:2 fluorotelomer alcohol (6:2 FTOH), Perfluorooctane sulfonic acid (PFOS)), a chlorinated organic compound (e.g., 1,2,3-Trichloropropane (TCP)), an explosive substance (e.g., Trinitrotoluene (TNT)), an industrial by-product (e.g., N-nitroso-dimethylamine (NDMA)), and Metolachlor.
